(19) United States
(12) Patent Application Publication
(10) Pub. No.: US 2015/0158569 A1
(43) Pub. Date: Jun. 11, 2015

(54) VESSEL PROPULSION WING

(71) Applicant: Paul-Henri DECAMP, Hinges (FR)

(72) Inventor: Paul-Henri Decamp, Hinges (FR)

(21) Appl. No.: 14/418,997

(22) PCT Filed: Aug. 5, 2013
(86) PCT No.: PCT/FR2013/051887

§ 371 Date: Feb. 2, 2015

(30) Foreign Application Priority Data
Sep. 3, 2012 (FR) 12 58195

(51) Int. Cl. B63H 9/06; H02S 20/30; B63H 9/10

(52) U.S. Cl. CPC B63H 9/0685; B63H 9/1021; B63H 9/0657; B63H 9/0607; H02S 20/30

(57) ABSTRACT

Propulsion wing of a vessel, having a sail, as well as a mast, defining a leading edge of the wing. The mast is segmented in sections. The wing is segmented in stages, each delimited by a lower spar and an upper spar connected to each section and extending substantially parallel to a horizontal plane. The sail is subdivided into at least two flaps, each associated with one stage, each flap movable between a deployed position in which the flap fills a space between the lower spar and the upper spar, thus offering a wind surface area, and a furled position in which the flap leaves open the space between the upper spar and the lower spar. The flaps of each stage are movable, independent of each other. The stages are movable in rotation with respect to the mast, independent of each other.

The invention concerns the propulsion of ships, and more particularly sail propulsion of ships. One of the first sources of propulsion of ships was the use of forces produced by sails. Sails work in two ways, either running before the wind, i.e. by orienting the sail perpendicular to the direction of the wind, or running close hauled, i.e. in a direction substantially parallel to the direction of the wind, thus creating a lift force capable of moving the boat.

It is known to use rigid sails instead of flexible sails due to the advantages that such rigid sails have with respect to flexible sails, particularly in terms of efficiency. Indeed, rigid sails allow ships to sail into the wind and induce less drag than a flexible sail. In general, it is desirable to reduce drag, which by definition opposes headway.

The document WO2004024556 (MARLIER, Jean-Louis) proposes an articulated rigid sail intended to ensure the propulsion by wind of an aquatic or land vehicle, comprising a mast on which a plurality of modules are mounted, spaced vertically apart, and to which a rigid shell forming a sail is fixed. Each module of two articulated sections makes it possible to curve the profile of the sail.

However, this sail has several disadvantages. First, the rigid shell is composed all of one piece. If the sail becomes damaged, it will then be completely unusable. Indeed, a tear in the shell would create an opening through which the wind would rush in and rip the shell, subjecting it to excessive pressure at the incipient break created by the damage.

Secondly, the document only presents the sail when it is in use. However, a rigid sail poses problems when the vessel is berthed. The sail surface enabling the vessel to make headway when it is under way remains subject to the forces exerted by the wind when the vessel is docked, which can be harmful for the vessel.

In this way, the vessel can lose stability due to the forces exerted by the wind on the sail on the one hand, and contrary forces exerted by the mooring lines on the other hand. In an extreme case, the vessel could be shorn in two under the stress of the two opposite forces. One solution for preventing damage to the vessel when it is docked consists of dismounting the sail and mast. This solution is effective, but has several disadvantages. Indeed, dismounting is a long process and can, in time, weaken the connections between the mast and the vessel, particularly the bearings allowing the rotation of the mast, as a result of successive dismounting and remounting. Moreover, once the sail and mast are dismounted, they must be stored in a safe place, where it will not be damaged and does not take up usable space.

To that end, a propulsion wing of a vessel is proposed, comprising a sail as well as a mast defining a leading edge of the wing, characterized in that:
the mast is segmented in sections;
the wing is segmented in stages, each delimited by an upper spar and a lower spar that are connected to each section and extending substantially parallel to a horizontal plane;
the sail is subdivided into at least two flaps, each associated with one stage, each flap being movable between a deployed position in which it fills a space between the lower spar and the upper spar, thus offering a wind surface area, and a furled position in which the flap leaves open the space between the upper spar and the lower spar;
the flaps of each stage are movable, independent of each other;
the stages are movable in rotation with respect to the mast, independent of each other.

Thanks to the possibility of furling and deploying the rigid sail based on needs, the performance of the wing is improved and the dismounting of the wing and of the rigid sail, when the vessel is docked, is eliminated, thus providing a gain in time for the crew and minimizing wear of the assembly parts.

Advantageously, the sail is composed of two flaps, opposite with respect to the axis of symmetry of the spars, coming together at the narrow end of the spars in the deployed position of the sail.

Each spar includes means of guiding the sail.

The flaps of each stage are synchronous in their furling and deployment movements.

According to one embodiment, the sail includes photovoltaic cells.

The mast has an electrical system allowing the circulation of the electric current to the vessel.

Each stage has an electrical system connected to the electrical system of the mast.

A base supports the first stage in such a way that it acts as adapter for mounting the mast on the securing device of the vessel.

Other characteristics and advantages of the invention will be seen more clearly and specifically from reading the following description of preferred embodiments, which is provided with reference to the appended drawings in which:

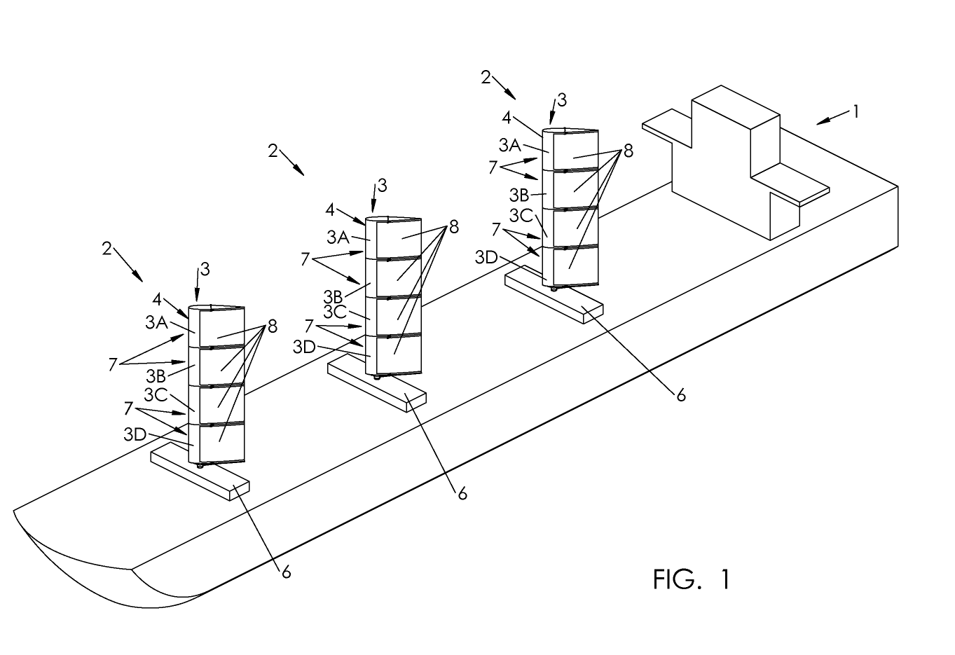

FIG. 1 is a view in perspective of a vessel having propulsion wings;

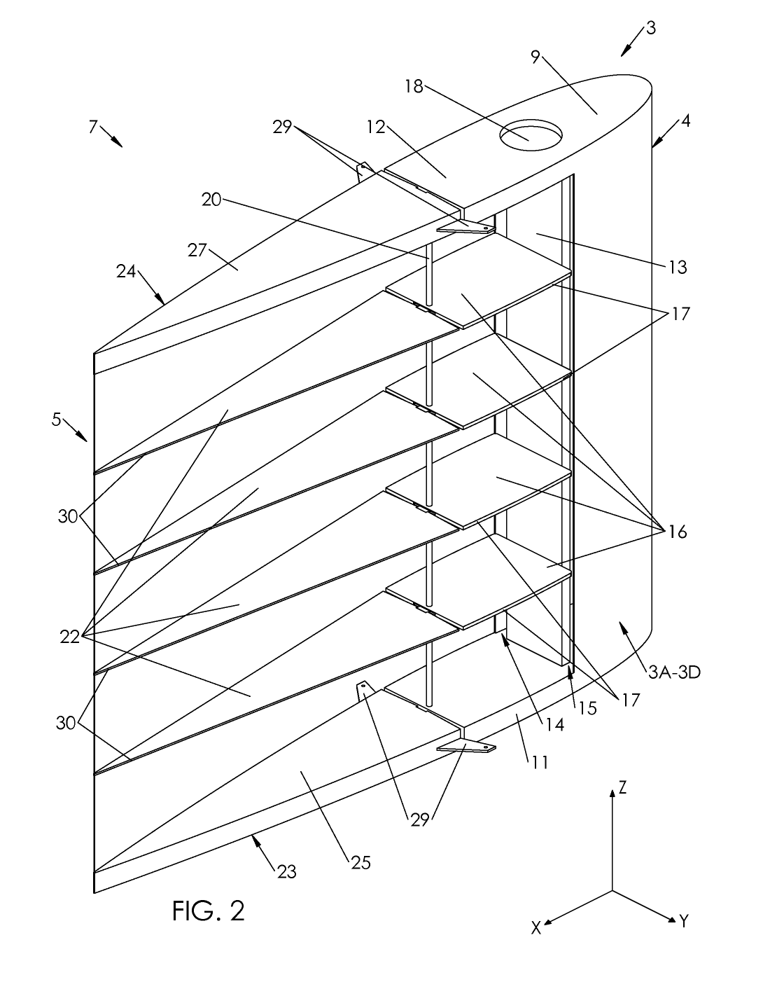

FIG. 2 is a view in perspective of one stage of the propulsion wing with the sail in the furled position;

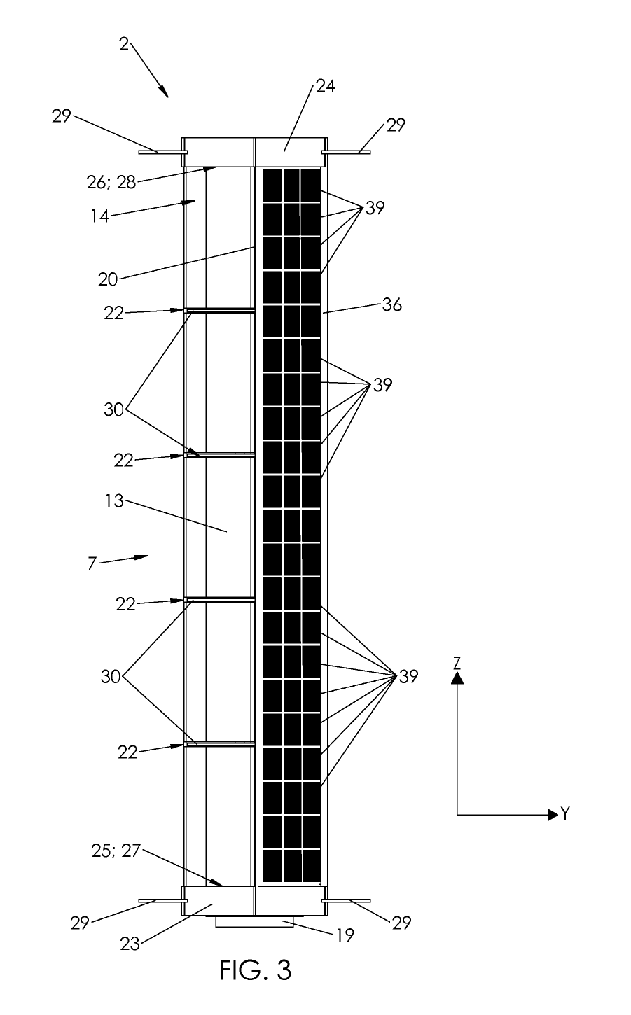

FIG. 3 is a front view of one stage of the propulsion wing showing a flap in the deployed position;

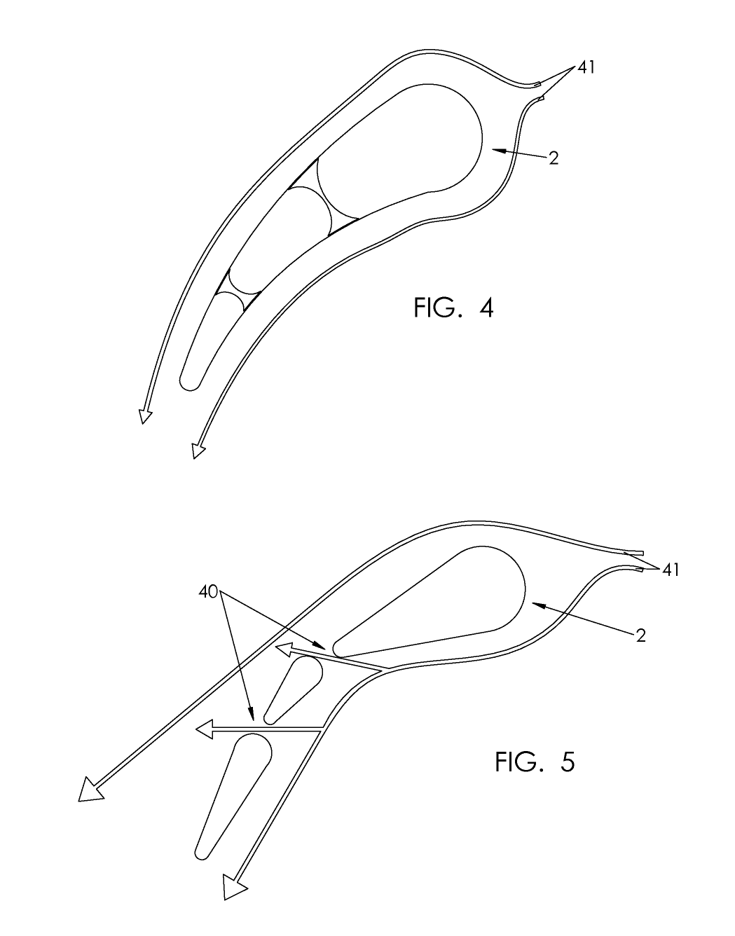

FIG. 4 is a schematic view showing the airflows over a propulsion wing with a single sail;

FIG. 5 is a schematic view showing the airflows over a propulsion wing with multiple sails;

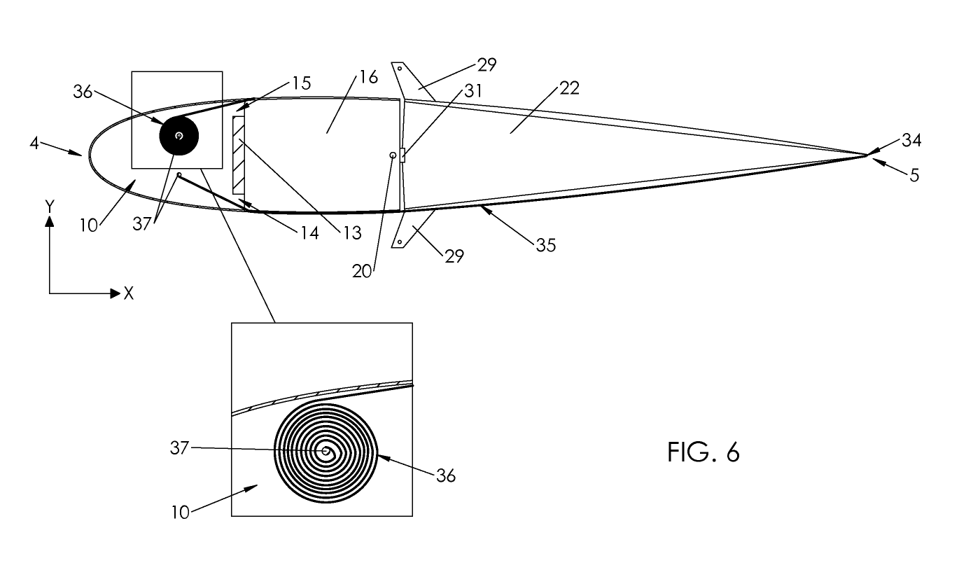

FIG. 6 is a view in transverse cross-section showing the furling and deployment mechanism of the sail;

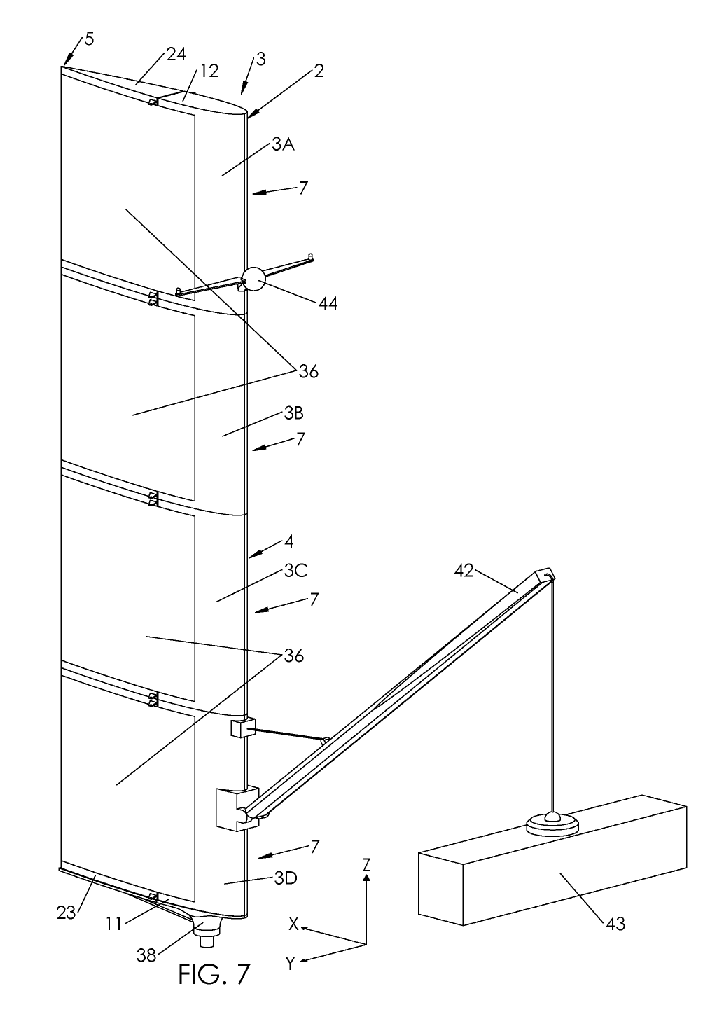

FIG. 7 is a view in perspective of a propulsion wing equipped with a lifting crane and navigation apparatuses.

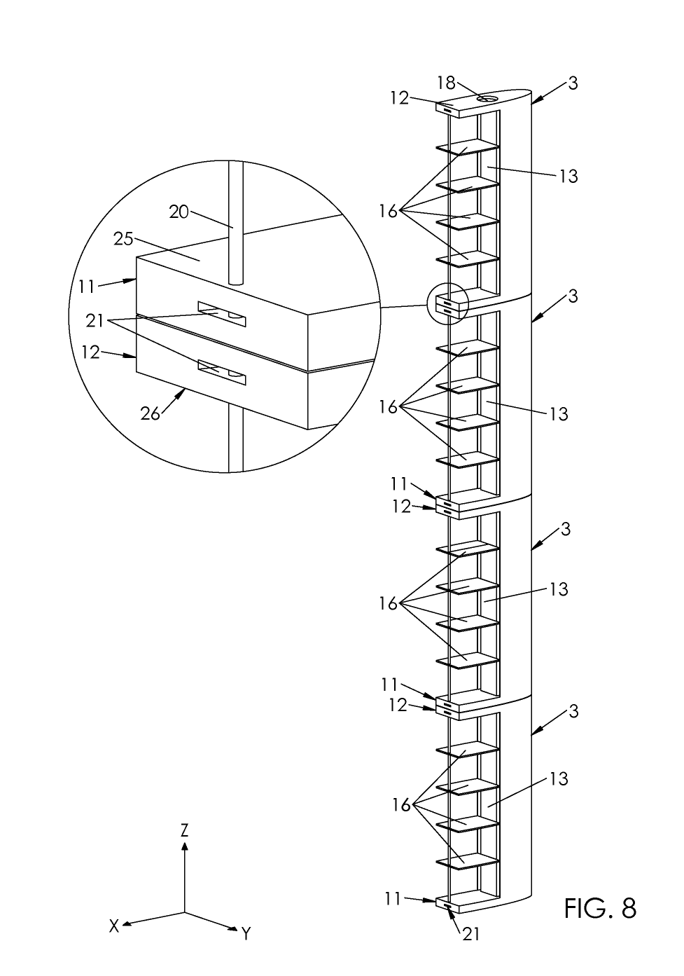

FIG. 8 is a view in perspective of the mast comprising a detail showing the cutouts enabling the assembly of the spars to the mast.

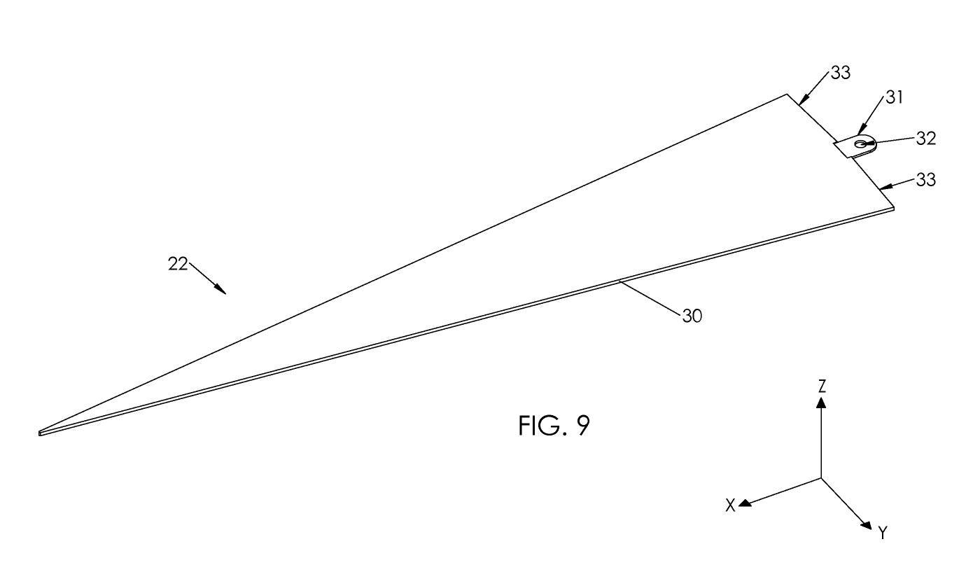

FIG. 9 is a view in perspective of a rib.

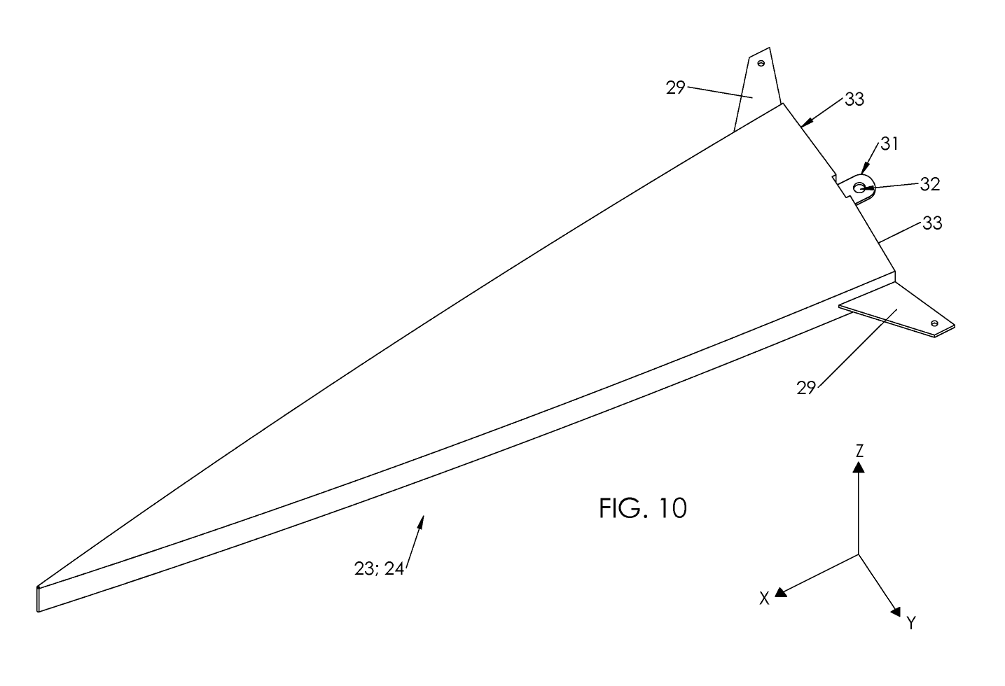

FIG. 10 is a view in perspective of a spar.

Represented in FIG. 1 is a vessel 1 having a wind propulsion system composed of three wings 2. The wings 2 are distributed over the length of the vessel 1 in such a way that one wing 2 cannot operate in the zone of action of another wing 2, more particularly, during rotation, two wings 2 cannot enter into contact with each other. The wings 2 are movable in rotation along an axis substantially perpendicular to the deck of the vessel 1.

An orthogonal system of reference XYZ, comprising three axes that are perpendicular two by two, is defined with respect to the wing 2, that is:
an X axis, defining a longitudinal direction, horizontal, aligned with the general direction of the wing 2 from the leading edge 4 towards the trailing edge 5,
a Y axis, defining a transverse direction, horizontal, which with the X axis defines a horizontal XY plane,
a Z axis, defining a vertical direction, perpendicular to the horizontal XY plane.
   The wings 2 comprise:
a rotary mast 3, segmented into sections 3A-3D, defining the leading edge 4 of the wing 2;
a device 6 to secure the mast 3 to the deck of the vessel 1, guiding the mast 3 in rotation along an axis substantially perpendicular to the deck and substantially parallel to the Z axis;
pairs of spars 23, 24 mounted on the mast 3, extending substantially parallel to a horizontal plane, jointly forming a stage 7;
a rigid sail 8, retractable between a position in which it is fully enclosed in the mast 3 and a deployed position in which it follows the external profile of the spars 23, 24 from the mast 3 to a narrow end of the spars 23, 24.

Each section 3A-3D of mast 3 is substantially semi-elliptical in shape and includes a hollow central body 9, forming a cavity 10 as well as two arms, i.e. an upper arm 12 and a lower arm 11, extending in a direction aligned with the X axis. The semi-elliptical shape is used in order to make it possible to utilize the mast 3 as leading edge 4 of the wing 2, although it could have a circular or triangular shape. The hollow central body 9 includes a rear opening at one end opposite the leading edge 4. A partition 13 partially closes the rear opening, extending substantially along the YZ plane between the lower arm 11 and the upper arm 12. Thus, a port slot 15 and a starboard slot 14 are left between the partition 13 and the lateral parts of the hollow central body 9 of the sections 3A-3D of the mast 3. The port slot 15 and the starboard slot 14 allow passage for the rigid sail 8, while the cavity 10 enables the rigid sail 8 to be accommodated when it is in the furled position.

Furthermore, the section 3A-3D of mast 3 also includes flats 16 projecting from the partition 13, oriented in a direction opposite to the leading edge 4 in a plane substantially perpendicular to the XY plane. Said flats 16 are regularly spaced from each other so that their side edges 17 can define support surfaces for the rigid sail 8 when said sail is in the deployed position. Viewed from above, the flats 16 are of equivalent shape to that of the upper arm 12 and the lower arm 11, although the width of the flats 16 is slightly less than the width of the upper arm 12 and the lower arm 11. According to one embodiment, there are four flats 16, although there could be more or fewer depending on the height of the section 3A-3D of mast 3 and the maximum height chosen between the flats 16.

The section 3A-3D of mast 3 includes, at its upper part, a recess 18 intended to receive rolling or sliding elements (not shown) to ensure good cooperation between two sections 3A-3D of mast 3. The section 3A-3D of mast 3 also includes a pin 19 at its lower part, intended to come into contact with the rolling or sliding elements of the lower section 3A-3D.

A metal rod 20 extends vertically between the upper arm 12 and the lower arm 11, at the central end thereof. The metal rod 20 passes through the different flats 16, thus making it possible to keep them straight and prevent their bending. The flats 16, as well as the lower arm 11 and the upper arm 12, comprise a cutout 21 at their end. Said cutout 21 is made around the metal rod 20 passing through these elements, enabling it to receive the junction parts of the secondary elements forming the wing 2, i.e., the spars 23, 24 and the ribs 22. Thus, the spars 23, 24 are mounted opposite the lower arm 11 and the upper arm 12, while the ribs 22 are mounted opposite the flats 16. The connections between the spars 23, 24 and the lower arm 11, firstly, and the upper arm 12, secondly, as well as between the ribs 22 and the flats 16, are accomplished by means of functional surfaces (not shown), such as bearings enabling the spars 23, 24 and ribs 22 to pivot around the metal rod 20. Said rotation thus enables the wing 2 to be curved, in order to optimize its performance.

There are two spars 23, 24, i.e. an upper spar 24 and a lower spar 23. The spars 23, 24 are substantially in the form of an isosceles triangle, the base being of a width substantially equal to the width of the ends of the arms 11, 12 of the section 3A-3D of the mast 3. The thickness of the spars 23, 24 is substantially equal to the thickness of the arms 11, 12 so that the space between the upper surface 25 of the lower spar 23 and the lower face 26 of the upper spar 24 is equal to the space between the upper area 27 of the lower arm 11 of the section 3A-3D of mast 3, and the lower plane 28 of the upper arm 12 of the section 3A-3D of mast 3. The shape of the spars 23, 24 is not limited to being triangular. Indeed, the spars 23, 24 could also have a semi-elliptical shape or trapezoidal shape, said shapes being used so that the end opposite the base has a width that is less than that of the width of the base.

On the sides of the spars, and more specifically near the wide part of the spars, fins 29 project in a plane substantially parallel to the spars 23, 24. The primary role of said fins 29 is to enable the rotational control of the spars 23, 24 with respect to the sections 3A-3D of mast 3, thanks to a system of pulleys and belts (not shown), the pulleys being in the lower arm 11 and the upper arm 12 of the sections 3A-3D. According to a particular embodiment, the rotational control of the spars 23, 24 could be done by means of hydraulic cylinders connected to the fins 29, as well as to the lower arm 11, and also the upper arm 12 of the sections 3A-3D.

As the flats 16 have a similar shape to the upper arm 12 and the lower arm 11, the ribs 22 have a shape similar to that of the spars 23, 24, their width also being slightly less than that of the spars 23, 24. The thickness of the ribs 22 is equal to that of the flats 16, and because these two elements are coplanar, the sides 30 of the ribs are also used as support surface for the rigid sail 8 when it is in the deployed position.

The attachment of the spars 23, 24 and of the ribs 22 to the sections 3A-3D is accomplished by means of tabs 31 mounted on the spars 23, 24, and on the ribs 22. The metal rod 20 passes through said tabs 31, enabling the spars 23, 24 and the ribs 22 to be guided in rotation. The tabs 31 are made in a flat, the thickness and width of which are less than the dimensions of the cutouts 21 made in the flats 16, the lower arm 11 and the upper arm 12 of the sections 3A-3D so as to ensure clearance, thus allowing rotation. A hole 32 slightly greater in diameter than the metal rod 20 is made in the upper surface of the flat, said hole cooperating with the metal rod 20 to produce the rotation of the spars 23, 24, and of the ribs 22.

The spars 23, 24 and the ribs 22 have, at their wide end, beveled cutouts 33. Said beveled cutouts 33 are made on the wide part of the spars 23, 24 and of the ribs 22, and extend from a point substantially near the center to the side parts. Said beveled cutouts 33 offer the possibility of making the spars 23, 24 and the ribs 22 pivot with respect to the sections 3A-3D of mast 3, while limiting the angular displacement, the beveled cutouts 33 acting as stops.

At the narrow end of the spars 23, 24, a nose 34 projects from the lower face 26 of the upper spar 24 to the upper surface 25 of the lower spar 23. Just as the flats 16 are attached to the metal rod 20, the ribs 22 are attached to the nose 34 so that they are unable to bend. The nose 34 also provides the function of cowling, i.e., it covers the rigid sail 8 at the narrow end of the wing 2 when said sail is deployed. The nose 34 can be made from a bent metal part, or from a molded plastic part; moreover, it enables the spars 23, 24 and the ribs 22 to be coupled, so that their rotational movement is joint.

One stage structure 7 of wing 2 comprises a section 3A-3D of mast 3, two spars 23, 24, a number of ribs 22 corresponding to the number of flats 16 included in the section 3A-3D of mast 3, a metal rod 20 and a nose 34. The addition of the rigid sail 8 and of the different control systems (rigid sail 8, mast 3, rotation of the secondary part) enables a complete stage 7 to be created for the wing 2.

For each stage 7, the rigid sail 8 is composed of two lateral flaps, i.e. a port lateral flap 36 and a starboard lateral flap 35. The flaps 35, 36 extend vertically between the upper area 27 of the lower arm 11 and the lower plane 28 of the upper arm 12 of the section 3A-3D of mast 3. By extension, the stage 7 comprising a secondary part defined by the spars 23, 24 and the ribs 22, the flaps also extend vertically between the upper surface 25 of the lower spar 23 and the lower face 26 of the upper spar 24. The rigid sail 8 thus is supported on the sides 17 of the flats 16, as well as on the sides 30 of the ribs 22. The flaps 35, 36 extend from the section 3A-3D of mast 3 to the nose 34, and more particularly, from the port slot 15 to the nose 34 for the port lateral flap 36, and from the starboard slot 14 to the nose 34 for the starboard lateral flap 35.

The flaps 35, 36 are connected to the arms 11, 12 and to the spars 23, 24 at their upper and lower ends by a guide system comprising a rail and a trolley (not shown in the figures). More specifically, the rail is secured to the arms 11, 12 and spars 23, 24, and the trolley is secured to the rigid sail 8. The rails are in two parts, a first part fixed to the arms 11, 12 and a second part fixed to the spars 23, 24. A flexible connector provides the connection between the two parts of rails and, because of its flexibility, allows the rotation of the spars 23, 24 with respect to the arms 11, 12. According to another embodiment, the rails could be replaced by grooves made in the arms 11, 12 and spars 23, 24, and the trolleys could be replaced by fingers cooperating with the grooves. Flexible tubes would then be used to connect the lower and upper grooves of the arms 11, 12 and spars 23, 24.

In a furled configuration, the port lateral flap 36 and the starboard lateral flap 35 are situated inside the hollow body of the mast 3, more particularly in the cavity 10. The flaps 35, 36 are rolled around a support 37, in this instance a tube, to which is attached a lateral end of the starboard lateral flap 35 or port lateral flap 36. When the sail is furled, it is then rolled around the support 37 and fully enclosed within the cavity 10. The sections 3A-3D of mast 3 include two supports 37, a port support and a starboard support, enabling the starboard lateral flap 35 and the port lateral flap 36 to be furled and stored in the cavity 10.

The flaps 35, 36 are moved into the furled or deployed configuration by means of two mechanisms (not shown), each comprising a set of pulleys, a cable and a motor. The motor drives the support 37 of the flap in rotation, thus providing a deployment or furling movement to the flap. A first pulley is secured to the support 37 while the second pulley is placed towards the trailing edge 5 of the wing, i.e. towards the end part of the spars 23, 24. The cable, connected to the flap at one of its ends and to the support 37 at its second end, moves the flap during its deployment, while in the reverse direction, it is the support 37 that drives the flap during its furling. The cable makes it possible to close a circuit so that the flap can be moved by means of a single motor.

According to a particular embodiment, the driving of the flaps 35, 36 in deployment or furling could be done by means of a chain mechanism, a gearing mechanism or by a motor equipping the flaps and moving on the aforementioned rails. The flaps 35, 36 are placed in motion synchronously. When the port lateral flap 36 is placed in motion, the starboard lateral flap 35 is also placed in motion. This makes it possible to prevent excessive pressure from being applied to one of the flaps, with the risk of damaging it.

The flaps 35, 36 are made of a material offering good characteristics of strength and rigidity, as well as good flexibility to enable them to be rolled around the support 37 in the furled configuration. Examples can be cited of sails woven from synthetic fibers such as nylon, aramid, polyethylene, polyester, polyazole or carbon.

The wing 2 rests on a base 38 that provides the connection between the attachment device 6 and the wing 2. The base 38 has a shape substantially similar to the profile of the wing, so that it is not visible from above when the wing 2 is not curved.

According to a particular embodiment, the flaps 35, 36 are equipped with photovoltaic cells 39 in order to generate electricity. Said photovoltaic cells 39 can be of amorphous technology, i.e. they are produced with a silicon base and enable electricity to be produced, even in low light. This technology also allows said photovoltaic cells 39 to be made flexible, so that they follow the flap 35 or 36 when it is in the furled position, i.e. rolled onto itself.

All of the photovoltaic cells 39 on the same flap 35 or 36 are electrically connected to each other by an electrical path, said electrical path being in series or shunt. Each stage 7 of the wing 2 then comprises a connector to which are connected the electrical paths of the starboard lateral flap 35 and the port lateral flap 36. Said connector itself is then connected to a principal system passing through the entire mast 3 and enabling the current produced by the photovoltaic cells 39 to be delivered to the vessel 1.

According to one embodiment, the photovoltaic cells 39 cover the entire rigid sail 8, although they could cover only one of the flaps 35 or 36, or part of one of the flaps 35 or 36, and not all of it.

The structure of the wing 2, i.e. the sections 3A-3D of mast 3, the flats 16, the spars 23, 24, the fins 29 and the ribs 22, are made of a material resistant both to high mechanical stresses and also to marine conditions. For example, this could include steel, stainless steel or aluminum, but also composite materials made of fibers and resin, such as fiberglass or carbon and epoxy resin. The choice of materials used is defined by the best compromise between durability, price and weight.

According to one embodiment, the flaps 35, 36 are continuous between the slots 14, 15 and the nose 34 of each stage 7. The flaps 35, 36 thus cover the flats 16 and the ribs 22. However, one variant could be used for the construction of the wing 2.

Indeed, the wing 2 could include three or more parts. The second part, comprising the spars 23, 24 and the ribs 22, would then be combined with the section 3A-3D of mast 3 to give a single, non-articulated sail. In this case, at least a second segment, similar to the first one, would be placed following the first one so as to create an articulation of the sail in order to adapt to the wind and increase its performance. This configuration would then use control means between each segment, said means being identical to those means described previously. In this configuration, the flaps 35, 36 of the rigid sail 8 would be independent for each segment. This would cause openings between each segment, forming gaps 40 for the airflows 41.

This configuration offers the advantage of increasing the performance of the wing 2. Indeed, the gaps 40 make it possible to accelerate the airflows 41 over the suction face of the wing 2, i.e. over the outer part of the wing 2 when it is curved, thus increasing the lift force, and therefore, the performance of the wing 2. This principle is based on the Venturi principle.

According to one embodiment, in which the flaps 35, 36 of rigid sail 8 would be of one single piece, each stage 7 would be composed of three or more parts. This configuration would thus offer the advantage of curving the wing 2 more subtly to adapt to the different wind conditions.

A remote control station enables the wing 2 to be maneuvered. The station can be located at the piloting controls of the vessel 1, at a dedicated console on the deck of the vessel 1, or both at the piloting controls of the vessel 1 and on the deck. The control of each wing 2 can be done simultaneously or separately, each wing 2 being independent with respect to the others.

According to one embodiment, the wing is only used as a simple means of propulsion. To that end, the wing 2 is attached to the vessel 1, perpendicular to the deck of the vessel 1, and can be oriented at 360° so that the mast 3 serves as leading edge 4 to the wing 2. Each stage 7 is curved in order to adapt the profile of the wing 2 to the needs, and similarly, the rigid sail 8 of each stage 7 is deployed or furled. Because each stage 7 is independent in rotation, each stage 7 can be oriented in a direction opposite to that of one of the upper or lower stages 7. Orienting each stage 7 in an opposite direction can make it possible to create a drag without creating lift, thus reducing the performance of the wing 2. This technique can be used to slow down the vessel 1.

According to another embodiment, the wing 2 can be used as support for various apparatuses. For example, as can be seen in FIG. 7, the mast 3 can serve as the attachment point for a crane 42. In a case where the wing 2 equips a vessel 1 of the type that carries containers, for example, a lifting crane 42 for the containers 43 could be an element of the vessel 1 itself, enabling containers 43 to be loaded and offloaded autonomously. The crane 42 would then be secured to a section 3A-3D of mast 3 and would be movable between a resting position, in which it would be parallel to the mast 3, and a working position, in which it would be at an angle to the mast 3. According to one embodiment, the mast 3 can provide a housing for the crane 42 so that, when the crane 42 is in the rest position and the vessel 1 is under way, the aerodynamism of the wing 2 is not degraded.

The mast 3 could also serve as support for different navigation apparatuses 44, such as beacons, lights, radar or horns.

Moreover, the wing 2 could also be equipped with firefighting means. To that end, the wing 2 could include fire control nozzles at each stage or a fire hose attached to a section 3A-3D of mast 3. The fire control means would then be remotely controlled from the piloting controls station and would use the possibility of 360° rotation of the mast 3 in order to increase the zone of action of the fire control means.

1. A propulsion wing of a vessel, comprising a sail, as well as a mast, defining a leading edge of the wing, characterized in that:
the mast is segmented in sections;
the wing is segmented in stages, each delimited by a lower spar and an upper spar that are connected to each section and extending substantially parallel to a horizontal plane;
the sail is subdivided into at least two flaps, each associated with one stage, each flap being movable between a deployed position in which the flap fills a space between the lower spar and the upper spar, thus offering a wind surface area, and a furled position in which the flap leaves open the space between the upper spar and the lower spar;
the flaps of each stage are movable, independent of each other;
the stages are movable in rotation with respect to the mast, independent of each other.

2. The wing according to claim 1, characterized in that the sail is composed of two flaps, that are opposite to the axis of symmetry of the spars, joining together at a narrow end of the spars in the deployed position of the sail.

3. The wing according to claim 1, characterized in that each spar includes means for guiding the sail .

4. The wing according to claim 1, characterized in that the flaps of each stage are synchronous in their furling and deployment movements.

5. The wing according to claim 1, characterized in that each sail includes photovoltaic cells.

6. The wing according to claim 1, characterized in that the mast has an electrical system enabling the circulation of electrical current to the vessel.

7. The wing according to claim 1, characterized in that each stage has an electrical system connected to the electrical system of the mast.

8. The wing according to claim 1, characterized in that a base supports the first stage in such a way that it acts as adapter for mounting the mast on the securing device of the vessel.
